(19) United States
(12) Patent Application Publication
(10) Pub. No.: US 2022/0356390 A1
(43) Pub. Date: Nov. 10, 2022

(54) Method For Determining The Formation Of A Winsor III Microemulsion System

(71) Applicants: TotalEnergies OneTech, Courbevoie (FR); ECOLE NATIONALE SUPERIEURE DE CHIMIE DE LILLE, Villeneuve d'Ascq (FR); CENTRE NATIONAL DE LA RECHERCHE SCIENTIFIQUE, Paris (FR); UNIVERSITE DE LILLE, Lille (FR)

(72) Inventors: Guillaume Lemahieu, Le Maisnil (FR); Jesus Fermin Ontiveros, Lille (FR); Jean-Marie Aubry, Oignies (FR); Valérie Molinier, Billère (FR)

(73) Assignees: CENTRE NATIONAL DE LA RECHERCHE SCIENTIFIQUE, Paris (FR); ECOLE NATIONALE SUPERIEURE DE CHIMIE DE LILLE, Villeneuve d'Ascq (FR); UNIVERSITE DE LILLE, Lille (FR); TotalEnergies OneTech, Courbevoie (FR)

(21) Appl. No.: 17/641,384

(22) PCT Filed: Sep. 9, 2019
(86) PCT No.: PCT/IB2019/001002

§ 371 Date: Mar. 8, 2022

(51) Int. Cl. C09K 8/584

(52) U.S. Cl. CPC C09K 8/584

(57) ABSTRACT

The invention relates to a dynamic method for determining the formation of a Winsor III microemulsion system, the method comprising the steps of: providing a mixture of an aqueous medium and a hydrocarbon medium in a chamber; continuously altering the concentration of at least one component in the mixture, while the ratio of the aqueous medium to the hydrocarbon medium remains constant and while stirring the mixture; and continuously measuring at least one physicochemical property of the mixture. The invention further relates to a device for determining the formation of a Winsor III microemulsion system.

### TECHNICAL FIELD

The present invention relates to a dynamic method for determining the formation of a Winsor III microemulsion system. The invention further relates to a device for determining the formation of a Winsor III microemulsion system.

### TECHNICAL BACKGROUND

Hydrocarbons (such as crude oil) are extracted from a subterranean formation (or reservoir) by means of one or more production wells drilled in the reservoir. Before production begins, the formation, which is a porous medium, is saturated with hydrocarbons.

The initial recovery of hydrocarbons is generally carried out by techniques of “primary recovery”, in which only the natural forces present in the reservoir are relied upon. In this primary recovery, only part of the hydrocarbons is ejected from the pores by the pressure of the formation. Typically, once the natural forces are exhausted and primary recovery is completed, there is still a large volume of hydrocarbons left in the reservoir.

This phenomenon has led to the development of enhanced oil recovery (EOR) techniques. Many of such EOR techniques rely on the injection of a fluid into the reservoir in order to produce an additional quantity of hydrocarbons.

The fluid used can in particular be an aqueous solution (“waterflooding process”), such as brine, which is injected via one or more injection wells.

Large amounts of water can also be recovered from the production wells. This is called “produced water”. The produced water can be e.g. discharged to the environment (after treatment) or reinjected into the subterranean formation via the injection wells.

A polymer can also be added to the water to increase its viscosity and increase its sweep efficiency in recovering hydrocarbons (“polymer flooding process”). In this case, the produced water contains part of the polymer, which can thus be recovered.

However, in a subterranean formation, droplets of hydrocarbons may be trapped in small cavities, therefore surfactants are often used for the mobilization of residual hydrocarbons, as they tend to generate a sufficiently low hydrocarbon/water interfacial tension which makes it possible to overcome capillary forces and allow hydrocarbons to flow. It is therefore important to be able to identify surfactant formulations capable of improving mobilization of residual hydrocarbons and therefore increasing hydrocarbon recovery. Furthermore, as the efficiency of the surfactant depends on the salinity of the (aqueous) medium used in the subterranean formation, it is also important to identify an optimal salinity for each surfactant formulation.

At this optimal salinity, the interfacial tension between the hydrocarbons and the aqueous phase is minimum, and when this tension reaches ultra-low values (<10² mN/m) the spontaneous formation of a microemulsion phase in equilibrium with an aqueous phase and a hydrocarbon phase occurs. Such three-phase system is called Winsor III and corresponds to the optimal formulation required for EOR applications.

Different methods have been described in the scientific literature and patents to identify experimental conditions leading to the optimal formulation. The most common one involves observing phase behaviour of surfactant/crude oil/water systems in the presence of increasing concentrations of salt. Some systems exhibit a three-phase behaviour, among them the system at the optimal formulation has a minimum water/hydrocarbon interfacial tension and has a microemulsion phase containing equal amounts of water and oil.

The article of R. M. Charin et al. (“Studies on transitional emulsion phase inversion using the steady state protocol”), 2015 (doi.org/10.1016/j.colsurfa.2015.08.003), relates to a study investigating the inversion process in emulsions by the steady state emulsification protocol. According to this article, salinity and co-surfactant composition were the manipulated variables to study whether emulsions could reach a phase transition.

The article of D. H. Smith et al. (“A study of the morphologies and inversions of model oilfield dispersions”), 1990 (doi: 10.2118/18496-PA) describes the determination of the emulsion morphologies and the phase volume fractions at which inversion occurs by using a surfactant/oil/water system and electrical conductivity measurements.

The article of J. L. Salager et al. (“Physico-chemical characterization of a surfactant, a quick and precise method”), 1983 (doi: 10.1080/01932698508943948) describes a method for characterizing a surfactant based on the attainment of optimum formulation for three-phase behavior and minimum interfacial tension.

The article of J. L. Salager et al. (“Surfactant-oil-water systems near the affinity inversion part I: relationship between equilibrium phase behavior and emulsion type and stability”), 1982 (doi.org:10.1080/01932698208943642) describes a systematic relationship found between the equilibrium phase behavior of a surfactant-oil-water system and the type and stability of the corresponding emulsion. According to this article, different formulations are scanned through the three-phase transition by changing (one at a time) brine salinity, oil EACN (equivalent alkane carbon number), surfactant nature and alcohol concentration and by carrying out conductivity measurements.

The article of J. L. Salager et al. (“Surfactant-oil-water systems near the affinity inversion part II: viscosity of emulsified systems”), 1983 (doi.org: 10.1080/01932698308943361) describes a relationship found between the equilibrium phase behavior of a surfactant-oil-water system and the viscosity of the corresponding emulsion. According to this article, when different formulations are scanned through the three-phase transition by changing (one at a time) brine salinity, oil EACN (equivalent alkane carbon number), surfactant HLB or alcohol concentration, the viscosity passes through a minimum for a three phase microemulsion-oil water.

The article of M. Bourrel et al. (“The relation of emulsion stability to phase behavior and interfacial tension of surfactant systems”), 1979 (doi.org/10.1016/0021-9797(79)90198-X) describes a close relationship between macroemulsion stability and optimum conditions at which a minimum interfacial tension is achieved between the oil and the microemulsion and between the aqueous and the microemulsion, and also at which the greatest solubilization of oil and electrolyte for a given amount of surfactant is achieved.

The article of J. Allouche et al. (“Simultaneous conductivity and viscosity measurements as a technique to track emulsion inversion by the phase-inversion-temperature method”), 2004 (doi.org/10.1021/la035334r) describes that the monitoring of emulsion conductivity and viscosity of a surfactant-oil-water system makes it possible to identify several phenomena taking place during a temperature decrease. According to this article, a viscosity maximum is found on each side of the three-phase behavior temperature interval that can correlate with the attainment of extremely fine emulsions.

The article of A. Pizzino et al. (“Light backscattering as an indirect method for detecting emulsion inversion”), 2007 (doi: 10.1021/la070090m) describes the detection of the emulsion inversion by monitoring the backscattering signal. According to this article, the backscattering data could shed light on emulsion morphology.

All these studies were conducted with model oils and surfactants under experimental conditions very different from those encountered in FOR where the temperature and the nature of the oil are imposed. Traditionally, the pipette method is used to identify the optimal formulation. More particularly, the crude oil (hydrocarbons) studied is introduced into a pipette in the presence of an equal volume of an aqueous solution containing a mixture of surfactants and a certain amount of salt. Each pipette contains a different amount of salt. Each pipette is sealed under nitrogen and equilibrated to the well temperature for very long times ranging from several weeks to several months. The optimum formulation corresponds to the pipette which has a middle microemulsion phase containing an equal amount of water and oil.

Therefore, there is a need for a dynamic method for identifying surfactant formulations leading to an optimal formulation, in an efficient, rapid and cost-effective manner. There is also a need for a method that allows the characterization of crude oil and FOR surfactant under experimental conditions close to the real conditions imposed by the FOR in terms of salinity and temperature.

### SUMMARY OF THE INVENTION

It is a first object of the invention to provide a dynamic method for determining the formation of a Winsor III microemulsion system, the method comprising the steps of:
providing a mixture of an aqueous medium and a hydrocarbon medium in a chamber;
continuously altering the concentration of at least one component in the mixture, while the ratio of the aqueous medium to the hydrocarbon medium remains constant and while stirring the mixture; and
continuously measuring at least one physicochemical property of the mixture.

According to some embodiments, the concentration of only one component in the mixture is altered, while the concentration of the other components of the mixture remains constant.

According to some embodiments, the aqueous medium is or derives from produced water, fresh water, aquifer water, formation water, sea water or combinations thereof.

According to some embodiments, the hydrocarbon medium is a hydrocarbon fluid recovered from a subterranean formation.

According to some embodiments, the mixture is initially a water-in-oil emulsion.

According to some embodiments, the mixture is initially an oil-in-water emulsion.

According to some embodiments, the ratio of the aqueous medium to the hydrocarbon medium is from 0.2 to 5, preferably from 0.5 to 2, and even more preferably the ratio of the aqueous medium to the hydrocarbon medium is approximately 1.

According to some embodiments, the mixture comprises a surfactant.

According to some embodiments, the surfactant has an initial concentration in the mixture from 0.001 to 30%, and preferably from 0.05 to 10% by weight of the total weight of the mixture.

According to some embodiments, the aqueous medium has an initial salinity from 0 to 300 g/L According to some embodiments, the mixture comprises a co-solvent.

According to some embodiments, the co-solvent has an initial concentration in the mixture from 0.001 to 30%, and preferably from 0.05 to 10% by weight of the total weight of the mixture.

According to some embodiments, the component is an inorganic salt, and/or a surfactant, and/or a co-solvent.

According to some embodiments, the surfactant is chosen from a surfactant of formula (VI):

R¹⁴—O—(CH₂—CH(CH₃)—O)ₖ—(CH₂CH₂O)ₚ—H (VI)

wherein:
R¹⁴ is a linear or branched alkyl group having from 1 to 24 carbon atoms and preferably from 10 to 18 carbon atoms;
p is a rational number from 1 to 30, preferably from 1 to 20 and even more preferably from 1 to 10;
k is a rational number from 0 to 30, preferably from 0 to 20 and even more preferably from 0 to 10;
and a surfactant of formula (VII):

R¹⁴—O—(CH₂—CH(CH₃)—O)ₓ—(CH₂—CH₂—O)_{y}—(CH₂)_{w}—X⁻M⁺ (VII)

wherein:
R¹⁴ is a linear or branched alkyl group having from 1 to 24 carbon atoms and preferably from 10 to 18 carbon atoms;
x is a number from 2 to 24, and preferably from 5 to 22. y is a number from 0 to 24; and
y is a number from 0 to 24, preferably from 0 to 10, more preferably from 0 to 5; and even more preferably from 0 to 2;
w is a number from 0 to 2;
X⁻ is an anionic group selected from the group of —OSO₃—, —R¹⁵—SO₃—, —SO₃—, or —R¹⁵—COO—; and
M⁺ is a hydrogen atom or a cation, preferably chosen from Li⁺, Na⁺ or K⁺;

as well as their mixtures.

According to some embodiments, the method comprises continuously adding an aqueous solution and additional hydrocarbon medium to the mixture in the chamber.

According to some embodiments, the method comprises continuously withdrawing part of the mixture from the chamber.

According to some embodiments, altering the concentration of at least one component is performed by increasing said concentration in the mixture.

According to some embodiments, the aqueous solution and/or the additional hydrocarbon medium comprises the component the concentration of which is altered, in a higher concentration than in the mixture.

According to some embodiments, the component is an inorganic salt, and the mixture has an initial salinity and the concentration of the inorganic salt in the mixture is increased by adding to the mixture a solution having a salinity higher than the initial salinity of the mixture.

According to some embodiments, the component is a surfactant, and the mixture has an initial surfactant concentration and the surfactant concentration in the mixture is increased by adding to the mixture a solution having a surfactant concentration higher than the initial surfactant concentration of the mixture.

According to some embodiments, the component is a co-solvent, and the mixture has an initial co-solvent concentration and the co-solvent concentration in the mixture is increased by adding to the mixture a solution having a co-solvent concentration higher than the initial co-solvent concentration of the mixture.

According to some embodiments, altering the concentration of at least one component is performed by decreasing its concentration in the mixture.

According to some embodiments, the aqueous solution and/or the additional hydrocarbon medium does not comprise the component the concentration of which is altered, or comprises the component the concentration of which is altered in a lower concentration than in the mixture.

According to some embodiments, the component is an inorganic salt, and the mixture has an initial salinity and the concentration of the salt in the mixture is decreased by adding to the mixture an aqueous solution having a salinity lower than the initial salinity of the mixture.

According to some embodiments, the component is the surfactant, and the mixture has an initial surfactant concentration and the surfactant concentration in the mixture is decreased by adding to the mixture an aqueous solution having a surfactant concentration lower than the initial surfactant concentration of the mixture.

According to some embodiments, the component is the co-solvent, and the mixture has an initial co-solvent concentration and the co-solvent concentration in the mixture is decreased by adding to the mixture a solution having a co-solvent concentration lower than the initial co-solvent concentration of the mixture.

According to some embodiments, the method is carried out at a constant temperature and/or at constant pressure.

According to some embodiments, the temperature is from 25 to 140° C., preferably from 40 to 120° C. and more preferably from 50 to 100° C.

According to some embodiments, the pressure is from 1 to 5 bars.

According to some embodiments, the physicochemical property of the mixture is chosen from conductivity, viscosity and light backscattering.

According to some embodiments, the physicochemical property is conductivity and the method further comprises a step of determining the concentration of the component at which the conductivity suddenly decreases from a value higher than 0 to substantially 0.

According to some embodiments, the physicochemical property is conductivity and the method further comprises a step of determining the concentration of the component at which the conductivity suddenly increases from a value of substantially 0 to a value higher than 0, preferably a value higher than 10 mS/cm.

It is a second object of the invention to provide a device for determining the formation of a Winsor III microemulsion system, the device comprising:
a chamber configured to receive a fluid sample;
at least two feed lines for continuously feeding two respective fluids to the chamber;
at least one discharge line for continuously withdrawing fluid from the chamber;
at least one sensor for measuring at least one physicochemical property of the fluid sample in the chamber; and
a stirring system for stirring fluid in the chamber.

According to some embodiments, the physicochemical property of the mixture is chosen from conductivity, viscosity and light backscattering.

According to some embodiments, the sensor is a conductivity sensor (5).

According to some embodiments, the device comprises a sensor for measuring the temperature of the fluid sample in the chamber.

According to some embodiments, the device further comprises a system for regulating the temperature of the chamber.

According to some embodiments, the stirring system is chosen from a magnetic stirrer and a stirring blade.

According to some embodiments, the feed lines are connected to or introduced into a single inlet of the chamber.

According to some embodiments, each feed line is connected to a syringe pump.

According to some embodiments, the device further comprises a cap for sealing the chamber.

According to some embodiments, the discharge line is connected to a discharge cell.

According to some embodiments, the fluid sample is a mixture of two fluids and preferably is a mixture of two liquids.

According to some embodiments, the first fluid of the mixture is an aqueous medium and the second fluid of the mixture is a hydrocarbon medium.

According to some embodiments, two different fluids are injected into the chamber, each fluid being injected through a different feed line.

The present invention makes it possible to address the need mentioned above. In particular the invention provides a method for identifying surfactant formulations leading to an optimal formulation, in an efficient, rapid and cost-effective manner. Furthermore, it provides a method that allows the characterization of crude oil and FOR surfactant under experimental conditions close to the real conditions imposed by the FOR in terms of salinity and temperature.

This is achieved by providing a mixture of an aqueous medium and a hydrocarbon medium, by continuously altering the concentration of at least one component in the mixture, while the ratio of the aqueous medium to the hydrocarbon medium remains constant and while stirring the mixture and by continuously measuring at least one physicochemical property of the mixture.

Generally, in order to develop an efficient surfactant composition, a widely used method consists in searching for a specific “phase behavior” of the mixture comprising hydrocarbons, water and surfactants. Therefore, after mixing these components and after decantation and phase separation, the state of the mixture is observed. According to the desired, specific phase behavior, three separated phases must be observed (one hydrocarbon phase, one aqueous phase and a microemulsion phase). This system is called “Winsor III” and is characterized in that it is stable over time and does not segregate into an oil phase and a water phase. This makes it possible to achieve an ultra-low interfacial tension between the hydrocarbon phase and the aqueous phase, which is necessary to properly displace the hydrocarbons. Therefore, surfactant formulations which are capable of forming a Winsor III microemulsion system may increase hydrocarbon recovery when injected in a subterranean formation. However, not all surfactant/water/oil systems are capable of achieving a Winsor III microemulsion system.

One way to identify such microemulsion is by scanning different surfactant compositions and different salinities of an oil-water mixture and observing a phase inversion from water-in-oil to oil-in-water emulsion or from oil-in-water to water-in-oil emulsion. As for example the electric conductivity of an oil-in-water emulsion is different from 0 and as the electric conductivity of a water-in-oil emulsion is essentially 0, a drastic increase or decrease of the conductivity makes it possible to identify the moment (as well as the conditions) of the inversion. Such inversion is not observed for surfactant compositions that do not form a Winsor III microemulsion system. Until now, the above-mentioned identification method has been carried out in a non-continuous manner, in graduated pipettes containing surfactant-oil-water systems with different salinities, as described above. This method increases the costs and duration of the operation. Similarly, viscosity and light backscattering can be used to identify the moment and conditions of the inversion.

The present invention makes it possible to continuously alter the concentration of at least one component in the mixture (comprising at least a hydrocarbon medium and an aqueous medium) and to continuously measure the conductivity (or viscosity or light backscattering) of the mixture in order to identify a Winsor III microemulsion system (when present) and therefore a surfactant formulation capable of increasing hydrocarbon recovery. Therefore, this dynamic method makes it possible to rapidly scan and identify such conditions while at the same time using a lower amount of hydrocarbons and surfactants, therefore decreasing the cost of the method.

Furthermore, notably when the component of which the concentration is altered is a salt (therefore altering the salinity of the mixture), the dynamic method of the invention makes it possible to rapidly identify the optimal salinity at which the surfactant formulation can be injected into the subterranean formation and increase hydrocarbon recovery.

### BRIEF DESCRIPTION OF THE DRAWINGS

FIG. 1 schematically illustrates the device according to one embodiment of the present invention.

FIG. 2 schematically illustrates the device according to another embodiment of the present invention.

FIGS. 3 and 4 illustrate the conductivity of different mixtures (both comprising a hydrocarbon medium and an aqueous medium) as a function of the salinity of the mixture. The conductivity (mS/cm) can be read on the Y-axis and the salinity (g/L) can be read on the X-axis.

### DESCRIPTION OF EMBODIMENTS

The invention will now be described in more detail without limitation in the following description.

The following description concerns the case wherein the conductivity of the mixture is measured in order to determine the formation of a Winsor III microemulsion system. However, viscosity or light back scattering can be measured in a similar and analogous way by adapting the device and method described below. See for example articles “Surfactant-oil-water systems near the affinity inversion part II: viscosity of emulsified systems” and “Simultaneous conductivity and viscosity measurements as a technique to track emulsion inversion by the phase-inversion-temperature method” (both cited above) for the measurement of viscosity.

### Device for Determining the Formation of a Winsor III Microemulsion System

The present invention relates to a device for determining the formation of a Winsor III microemulsion system.

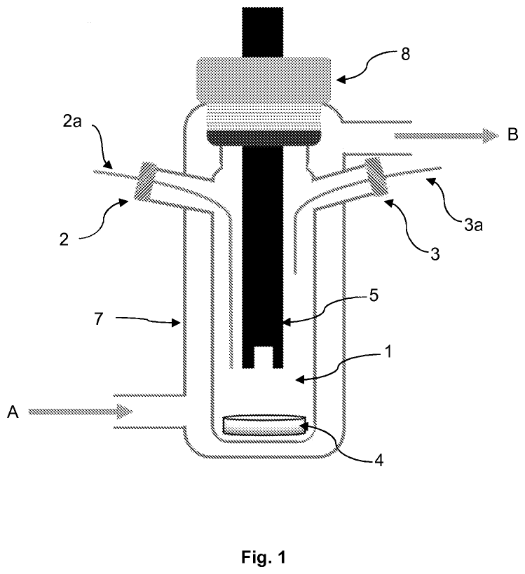

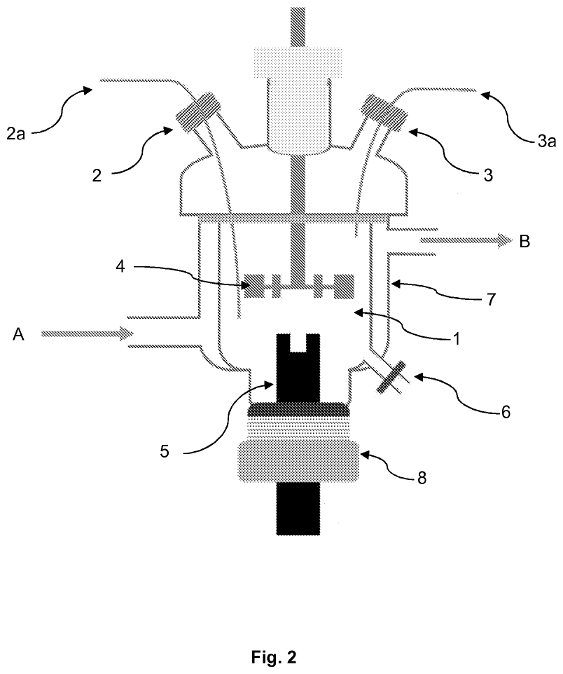

Making reference to FIGS. 1 and 2, the device according to the invention comprises a chamber 1 configured to receive a fluid sample. Preferably, the fluid sample is a liquid.

According to some embodiments, the fluid sample is a mixture of different fluids, and is preferably a mixture of an aqueous medium and a hydrocarbon medium. One or more salts (for example inorganic salts) and/or one or more surfactants and/or one or more co-solvents and/or other additives may also be present in the mixture. The additives may be e.g. present at a content from 0.001 to 10% by weight of the total weight of the mixture.

The chamber 1 may be fabricated from a material chosen from chemical-resistant glasses.

The chamber 1 may have a volume from 1 to 1000 mL, preferably from 5 to 100 mL and even more preferably from 5 to 50 mL.

The device according to the invention, and more particularly the chamber 1 is provided with at least one inlet 2 and at least one outlet 3 for the entry and exit of fluid.

The device is provided with at least two feed lines 2a. This means that two different fluids can be independently introduced into the chamber 1 at the same time, each one from a different feed line 2a.

In some embodiments, the feed lines 2a may be connected to different inlets 2 of the device. Alternatively, a downstream portion of each feed line 2a may be introduced into the chamber via a respective inlet 2.

In other embodiments, the feed lines 2a may be connected to a single inlet 2 of the device.

For example, the feed lines 2a may be connected to a single feeding conduit which is then connected to the single inlet 2 of the device. Alternatively, a downstream portion of the single feeding conduit may be introduced into the chamber via the single inlet 2.

Alternatively, the feed lines 2a may be directly and separately connected to the single inlet 2 of the device. Or a downstream portion of the feed lines 2a may be introduced into the chamber via the single inlet 2, as illustrated in the drawing (only one of the feed lines 2a being shown).

If a feed line 2a or a feeding conduit is introduced into the chamber via an inlet 2, a sealing between the feed line(s) 2a or the feeding conduit and the inlet 2 is provided.

According to some embodiments, the device is provided with only two feed lines 2a.

According to other embodiments, the device is provided with more than two feed lines 2a, for example three, or four, or five, or more than five feed lines 2a. Preferably, the device is provided with three feed lines 2a.

According to preferred embodiments, each feed line 2a may be connected to a syringe pump (not shown in figures). Therefore, each fluid may be introduced into the chamber 1 at an adjustable (preferably constant) flow rate, owing to the syringe pump. This flow rate may be the same or different for each fluid being introduced through a different feed line 2a. In other words, a first fluid entering the chamber 1 via a first feed line 2a may have a certain flow rate, and a second fluid entering the chamber 1 via a second feed line 2a may have a different flow rate. Preferably, all fluids entering the chamber 1 have the same flow rate.

Alternatively, each feed line 2a may be connected to a respective fluid tank.

The outlet 3 of the chamber 1 is provided with at least one discharge line 3a. The discharge line 3a may be connected to a discharge cell (not shown in figures). The discharge line 3a makes it possible to remove an amount of the mixture from the chamber 1 and place it in the discharge chamber for example.

Preferably, the removal of mixture is performed continuously, and simultaneously with the introduction of fluid via the feed lines 2a. This makes it possible to maintain a substantially constant volume of fluid in the chamber 1.

The device according to the invention further comprises a stirring system 4 located in the chamber 1. The stirring system 4 makes it possible to efficiently mix all components and/or fluids present in the chamber 1 in order to create an emulsion.

The stirring of the mixture may be magnetic stirring or mechanical stirring. Therefore, the stirring system may be for example chosen from a magnetic stirrer such as a magnetic stir bar (shown in FIG. 1), a mechanical stirring such as a stirring blade, or spiral or Moebius stirrers (shown in FIG. 2).

In case large volumes of fluid sample are introduced into the chamber 1, for example volumes higher than 10 mL, or 15 mL, or 20 mL, or 25 mL, or 30 mL, it is preferable to use a mechanical stirring system as it may offer more powerful and efficient stirring. Such stirrer may further be used in case the fluid sample has a relatively high viscosity. Such viscosity may be for example equal to higher than 40 mPa·s at the temperature of use.

The stirring of the fluid sample may be carried out for example at a rotational speed from 200 to 2000 rpm, and preferably from 400 to 1000 rpm.

Furthermore, the device according to the invention comprises at least one conductivity sensor 5. The conductivity sensor 5 makes it possible to continuously measure the conductivity of the fluid sample in the chamber 1. Therefore, the conductivity sensor 5 may be placed in the chamber 1 so that at least one part of the sensor 5 (the part of the sensor 5 that is responsible for the conductivity measurement) is in contact with the fluid sample. Preferably this part of the sensor 5 is immersed in the fluid sample.

According to some embodiments, the device may further comprise a sensor for measuring the temperature of the fluid sample in chamber 1 (not shown in figures). Preferably, this sensor is integrated with the conductivity sensor. The temperature sensor makes it possible to continuously measure the temperature of the fluid sample in the chamber 1. Therefore, the temperature sensor may be placed in the chamber 1 so that at least one part of the sensor (the part of the sensor that is responsible for the temperature measurement) is in contact with the fluid sample. Preferably this part of the sensor is immersed in the fluid sample.

According to some embodiments, the conductivity sensor 5 and/or the temperature sensor may be located in an upper part of the chamber 1 (as shown in FIG. 1). Alternatively, the conductivity sensor and/or the temperature sensor may be located in a lower part of the chamber 1 (as shown in FIG. 2).

In addition, one or more pumps may be comprised, therefore connected to the device according to the invention. Such pumps may for example be connected to the feed lines 2a and/or the discharge line 3a in order to regulate the circulation of fluid (for example the flow rate) entering and exiting the chamber 1.

According to some embodiments, the device according to the invention may comprise one or more valves. Such valves (not shown in figures) may be for example valves located at the inlet and/or outlet of the chamber, making it possible to close, if desired, the chamber. Alternatively (and as shown in FIG. 2), such valve may be for example a draining valve 6 preferably located at a lower (bottom) part of the chamber 1 and making it possible, when open, to completely empty the fluid sample from the chamber 1.

The device according to the invention may further comprise a temperature regulation system, which may comprise a heating and/or a cooling system. For example, use can be made of a refrigerant circuit and/or resistive heating. According to preferred embodiments and as shown in FIGS. 1 and 2, the temperature regulation system may comprise an enclosure 7 covering at least part of the chamber 1 and in which circulates a temperature-controlled fluid. For example, in FIGS. 1 and 2, arrow A indicates the entrance of such fluid in the enclosure 7 and arrow B indicates the exit of such fluid from the enclosure 7.

According to some embodiments, the chamber 1 may be integrally formed as a single part.

According to other embodiments, the chamber 1 may be formed from the assembly of two or more than two parts, for example one part that forms the internal space of the chamber 1 for receiving the mixture and another part that comprises the inlet 2 and/or the outlet 3 of the chamber 1 and that makes it possible to close the chamber 1.

The device according to the invention may further comprise a cap 8. In fact, in case the chamber 1 comprises a part on its surface that is not-covered or not entirely covered, the cap 8 makes it possible to seal the not-covered surface of the chamber 1. Preferably, the chamber 1 should be sealed by the cap 8 in a gas-tight manner. The cap 8 may be screwed on or clipped to the chamber 1. Alternatively, this cap 8 may be fixed to the chamber 1 by one or more clamps.

According to some embodiments, the cap 8 may comprise an opening. This opening makes it possible to pass for example the conductivity sensor 5 and/or the temperature sensor through the cap 8 so that when the cap 8 is fixed to the chamber 1 one part of the sensor is located in the chamber 1 and another part of the sensor is located outside the chamber 1 (this is illustrated in FIGS. 1 and 2). In this case, the cap 8 may comprise one or more sealants (not shown in figures) to assure gas-tightness between the sensor and the cap 1.

The device of the invention may also comprise—or be associated in a larger system with—an analysis module and/or a control module.

The analysis module may receive data from the conductivity and/or temperature sensors and provide analysis data as an output.

The control module may receive data from the user and/or from the analysis module and may send instructions which make it possible to actuate the syringe pumps for example, as well as the various valves of the device. It is possible to operate the device in an automated or semi-automated manner, using appropriate computer hardware and software.

### Method for Determining the Formation of a Winsor III Microemulsion System

The present invention further relates to a dynamic method for determining the formation of a Winsor III microemulsion system. This method is preferably implemented in the device described above.

The method first comprises a step of mixing an aqueous medium and a hydrocarbon medium in order to provide a mixture. In order to provide this mixture, the two mediums can be introduced for example in the chamber 1 of the device described above.

According to some embodiments, the two mediums may be introduced simultaneously into the chamber 1 for example via two different feed lines 2a.

According to other embodiments, a first of the two mediums may be introduced in the chamber 1 through a first feed line 2a and then the introduction of a second of the two mediums may follow from the same feed line 2a or from a second feed line 2a.

The aqueous medium may be or may derive from produced water, fresh water, aquifer water, formation water and sea water.

According to some embodiments, the aqueous medium may have an initial salinity from 0 to 300 g/L. For example, the aqueous solution may have a salinity from 0 to 50 g/L; or from 50 to 100 g/L; or from 100 to 150 g/L; or from 150 to 200 g/L; or from 200 to 250 g/L; or from 250 to 300 g/L. Salinity is defined herein as the total concentration of dissolved inorganic salts in water, including e.g. NaCl, CaCl₂), MgCl₂, Na₂CO₃ and any other inorganic salts.

In other words, the mixture may comprise one or more inorganic salts chosen from NaCl, CaCl₂, MgCl₂ and any other inorganic salts.

The hydrocarbon medium is preferably a hydrocarbon fluid recovered from a subterranean formation. It is preferably a complex fluid comprising various hydrocarbon compounds and optionally water as well as contaminants or chemicals used in the process of hydrocarbon recovery (surfactants, co-solvents, etc.).

The hydrocarbon medium may have a viscosity from 10 to 400 mPa·s and preferably from 10 to 250 mPa·s. For example, this viscosity may be from 10 to 50 mPa·s; or from 50 to 100 mPa·s; or from 100 to 150 mPa·s; or from 150 to 200 mPa·s; or from 200 to 250 mPa·s; or from 250 to 300 mPa·s; or from 300 to 350 mPa·s; or from 350 to 400 mPa·s. The viscosity can be measured by using a kinematic viscosimeter.

According to some embodiments, the initially provided mixture is a water-in-oil emulsion.

According to other embodiments, the initially provided mixture is an oil-in-water emulsion.

According to some embodiments, the ratio of the aqueous medium to the hydrocarbon medium may be from 0.2 to 5, and preferably from 0.5 to 2.

According to preferred embodiments, the ratio of the aqueous medium to the hydrocarbon medium may be around 1. For example, this ratio may be from 0.1 to 0.5; or from 0.5 to 1; or from 1 to 2; or from 2 to 3; or from 3 to 4; or from 4 to 5; or from 5 to 6; or from 6 to 7; or from 7 to 8; or from 8 to 9; or from 9 to 10.

The mixture of the aqueous medium and the hydrocarbon medium may also comprise at least one surfactant. According to preferred embodiments, the mixture of the aqueous medium and the hydrocarbon medium may comprise more than one surfactants.

Such surfactant may be for example an alkyl betain compound of formula (I):

R¹—N⁺(R²)R^{2′}—CH₂OOO⁻ (I)

R¹ may be chosen from an alkyl or an alkenyl group having from 1 to 24 carbon atoms, preferably from 8 to 16, and more preferably from 10 to 14 carbon atoms.

R² and R^{2′} may independently be chosen from an alkyl group having from 1 to 10 carbon atoms. Preferably, R² are methyl groups.

Alternatively, such surfactant may be for example a N-oxide compound of formula (II):

R¹—N⁺(R²)R²′—O⁻ (II)

R¹, R² and R^{2′} may be as described above.

Alternatively, such surfactant may be for example an amphoteric compound of formula (III):

R³—N(R⁴)—R⁵ (III)

R³ may be chosen from an alkyl or alkenyl group having from 1 to 24 carbon atoms, preferably 8 to 16, and even more preferably from 10 to 14 carbon atoms.

Alternatively, R³ may be chosen from a group R⁶CO—, wherein R⁶ may preferably be a linear alkyl or alkenyl group having from 7 to 15, preferably from 9 to 13 carbon atoms, or from a group R⁶CO—NH—R⁷—, wherein R⁶ may be as defined above, and R⁷ may be an alkylene group having from 1 to 4 carbon atoms, preferably 2 carbon atoms. Preferably R⁷ may be a 1,2-ethylene group (—CH₂—CH₂—).

R⁴ and R⁵ may independently be chosen from an ω-carboxyalkyl group having the formula —(CH₂)ₙ—COO⁻M⁺, wherein M⁺ may be a hydrogen atom or a cation, preferably chosen from Li⁺, Na⁺ or K⁺, and n may be a number from 1 to 10, preferably 1 to 4, and most preferably 2, or from an w-hydroxyalkyl group having the formula —(CH₂)ₙ—OH, wherein n may be as described above, or from a group having the formula —(CH₂CH₂—R⁸)ₘ—R⁹—COO⁻M⁺ wherein M⁺ may be as described above, m may be a number from 1 to 10, preferably 1 to 4, and most preferably 1, R⁸ may be selected from —O— and —NH— and R⁹ may be an alkylene group having 1 to 4, preferably 1 or 2 carbon atoms, more preferably a methylene group (—CH₂—).

Alternatively, such surfactant may be for example a compound of formula (IV):

[R¹⁰—N(R¹¹)(R¹²)—R¹³]⁺A⁺ (IV)

R¹⁰, R¹¹, R¹² and R¹³ may be independently chosen from an alkyl radical having from 1 to 20 carbon atoms, preferably from 1 to 15 carbon atoms. R¹⁰, R¹¹, R¹² and R¹³ may be linear or branched alkyl radicals.

A⁻ may be a halogen anion. A⁻ may be chosen from F⁻, Cl⁻, Br⁻ and I⁻.

Alternatively, such surfactant may be for example a compound of formula (V):

R¹⁴—(OCH₂CH₂)ₚ—X⁺M⁺ (V)

R¹⁴ may be a linear or branched alkyl group having from 1 to 24 carbon atoms and preferably from 10 to 18 carbon atoms.

p may be a rational number from 1 to 30, preferably from 1 to 20 and even more preferably from 1 to 10.

X⁻ may be an anionic group selected from the group of —OSO₃—, —R¹⁵—SO₃—, —SO₃—, or —R¹⁵—COO—.

R¹⁵ may be an alkylene group having from 1 to 10 carbon atoms.

M⁺ may be as described above.

Alternatively, such surfactant may be for example a compound of formula (VI):

R¹⁴—O—(CH₂—CH(CH₃)—O)ₖ—(CH₂CH₂O)ₚ—H (VI)

R¹⁴ and p may be as described above.

k may be a rational number from 0 to 30, preferably from 0 to 20 and even more preferably from 0 to 10.

Alternatively, such surfactant may be for example a compound of formula (VII):

R¹⁴—O—(CH₂—CH(CH₃)—O)ₓ—(CH₂—CH₂—O)_{y}—(CH₂)_{w}—X⁻M⁺ (VII)

R¹⁴ may be as described above.

x may be a number from 2 to 24, and preferably from 5 to 22. y is a number from 0 to 24.

y may be a number from 0 to 24, preferably from 0 to 10, more preferably from 0 to 5; and even more preferably from 0 to 2.

w may be a number from 0 to 2.

X⁻ and M⁺ may be as described above.

Alternatively, such surfactant may be for example a compound of formula (VIII):

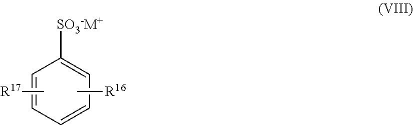

R¹⁶ and R¹⁷ may be independently chosen from a hydrogen atom, or an alkyl radical having from 1 to 24 carbon atoms, preferably from 5 to 15 and more preferably from 8 to 13 carbon atoms. R¹⁶ and R¹⁷ may be linear or branched alkyl radicals.

Alternatively, such surfactant may be for example a compound of formula (IX):

R¹⁸-(G)ₒ-O—R¹⁹ (IX)

R¹⁸ may be a hydrogen atom or a linear or a branched alkyl radical having from 1 to 15 carbon atoms and preferably from 1 to 10 carbon atoms.

R¹⁹ may be a hydrogen atom or a linear or a branched alkyl radical having from 6 to 22 carbon atoms, preferably from 8 to 20, and even more preferably from 8 to 16 carbon atoms.

G may be a glucoside. Glucoside is a glycoside derived from glucose.

Therefore, G has the molecular formula C₆H₁₀O₅ and is a six-membered ring.

o may be a number from 1 to 10, preferably from 1 to 5, and more preferably from 1 to 3.

Alternatively, such surfactant may be for example a compound of formula (X):

R¹⁸-(G)ₒ-(R¹⁹—COO⁻M⁺)_{q} (X)

R¹⁸, G, o and M may be as described above.

R¹⁹ may be a divalent hydrocarbon group comprising from 1 to 10 carbon atoms, or a divalent ester group —C(O)—O—R²⁰—, wherein R²⁰ may be a hydrocarbon group comprising 1 to 10 carbon atoms.

q may be a number from 1 to 4, and preferably from 1 to 2.

Alternatively, such surfactant may be for example a compound of formula (XI):

R¹⁵OSO₃-M⁺ (XI)

R¹⁵ and M⁺ are as described above.

According to preferred embodiments, the one or more surfactants may preferably have the formula (VI) and/or the formula (VII).

Combinations of the above surfactants may also be used.

The surfactant(s) may have an initial concentration in the mixture from 0.001 to 30%, and preferably from 0.05 to 10% by weight of the total weight of the mixture. For example, the surfactant(s) may have an initial concentration in the mixture from 0.001 to 0.01%; or from 0.01 to 1%; or from 1 to 2%; or from 2 to 4%; or from 4 to 6%; or from 6 to 8%; or from 8 to 10%; or from 10 to 12%; or from 12 to 14%; or from 14 to 16%; or from 16 to 18%; or from 18 to 20%; or from 20 to 22%; or from 22 to 24%; or from 24 to 26%; or from 26 to 28%; or from 28 to 30% by weight of the total weight of the mixture.

Furthermore, the mixture may comprise more than one co-solvents. The co-solvents may be chosen from short-chain polyalkoxylated alcohols and short-chain alcohols.

The co-solvent(s) may have an initial concentration in the mixture from 0.001 to 30%, and preferably from 0.05 to 10% by weight of the total weight of the mixture. For example, the co-solvent(s) may have an initial concentration in the mixture from 0.001 to 0.01%; or from 0.01 to 1%; or from 1 to 2%; or from 2 to 4%; or from 4 to 6%; or from 6 to 8%; or from 8 to 10% %; or from 10 to 12%; or from 12 to 14%; or from 14 to 16%; or from 16 to 18%; or from 18 to 20%; or from 20 to 22%; or from 22 to 24%; or from 24 to 26%; or from 26 to 28%; or from 28 to 30% by weight of the total weight of the mixture.

The mixture may further comprise additives such as polymers, sacrificial agents, mobility pH adjustment agents, anti-corrosion agents, demulsifiers, hydrate inhibitors, anti-scale agents, biocides and mixtures thereof.

Preferably, the mixture is devoid of additives.

According to some embodiments, the mixture initially has a salinity of 0 (or of essentially 0) and comprises at least one surfactant and/or at least one co-solvent.

According to other embodiments, the mixture has a salinity different from 0, and comprises at least one co-solvent and is devoid of surfactant.

According to other embodiments, the mixture has a salinity different from 0, and comprises at least one surfactant and is devoid of co-solvent.

The method according to the invention further comprises a step of continuously altering the concentration of at least one component in the mixture while stirring the mixture. During this step, the ratio of the aqueous medium to the hydrocarbon medium remains constant. This is made possible by appropriately adjusting the flow rates of the fluids introduced into the chamber and optionally the withdrawn from the chamber.

By “continuously altering” is meant that the concentration of the component is altered in a continuous manner, in other words the concentration of the component is altered throughout the whole duration of the step. During this step of continuously altering the concentration of at least one component in the mixture the mixture is stirred in order to obtain an emulsion.

The at least one component can be chosen from an inorganic salt, a surfactant, and a co-solvent.

The inorganic salt may be chosen from NaCl, CaCl₂, MgCl₂ and any other inorganic salts or combination thereof.

The surfactant and the co-solvent may be as described above.

When the component is an inorganic salt, the salinity of the mixture may be altered.

Preferably, during this step, the concentration of a single component is altered relative to the initial concentration of the component in the mixture, while the concentration of the other components remains the same.

According to some embodiments, the concentration of an inorganic salt is altered relative to the initial concentration of the inorganic salt in the mixture, while the concentration of the surfactant and/or the concentration of the co-solvent preferably remains constant.

According to other embodiments, the concentration of the surfactant is altered relative to the initial concentration of the surfactant in the mixture, while the concentration of the inorganic salt and/or the concentration of the co-solvent preferably remains constant.

According to other embodiments, the concentration of the co-solvent is altered relative to the initial concentration of the co-solvent in the mixture, while the concentration of the surfactant and/or the concentration of the inorganic salt preferably remains constant.

According to some embodiments, “altering the concentration of atleast one component” means that its concentration increases during this step compared to its initial concentration.

According to other embodiments, “altering the concentration of at least one component” means that its concentration decreases during this step compared to its initial concentration.

However, it is also possible to first continuously increase the concentration of at least one component for a certain duration, and then continuously decrease its concentration for another certain duration. Or to first continuously decrease the concentration of at least one component for a certain duration, and then continuously increase its concentration for another certain duration.

Yet according to other embodiments, during a first period of time the concentration of a first component may be altered while the concentration of the other components remains constant, and for a second period of time the concentration of a second component may be altered while the concentration of the first component and of the other components remains constant.

According to some embodiments, during this step the salinity of the mixture is increased (which means that the concentration of inorganic salt(s) in the mixture is increased). To do so, an aqueous solution having a salinity higher than the initial salinity of the mixture (for example a salinity of 300 g/L) may be continuously added into the mixture. In this case, the initial salinity of the mixture may be approximately 0. Therefore, the continuous addition of a solution of high salinity into the mixture of low or zero salinity results in the continuous increase of the salinity of the mixture. By “continuously added” is meant that the addition of the solution having a salinity higher than the initial salinity of the mixture is not fractionate or discontinuous but a continuous injection or introduction of the solution in the mixture.

According to other embodiments, during this step the salinity of the mixture decreases (which means that the concentration of inorganic salt(s) in the mixture decreases). To do so, an aqueous solution having a salinity lower than the initial salinity of the mixture (for example a salinity of approximately 0 g/L) may be continuously added into the mixture. Therefore, the continuous addition of a solution of low or zero salinity into the mixture of high salinity results in the continuous decrease of the salinity of the mixture.

In both cases, in order to keep the ratio of the aqueous medium to the hydrocarbon medium as well as (preferably) the concentration of the other components (surfactants, co-solvents) in the mixture constant during the step, additional hydrocarbon medium, an aqueous solution comprising the surfactant, and/or an aqueous solution comprising the co-solvent may be added into the mixture. In this case, the aqueous solution having a lower or a higher salinity than the initial salinity of the mixture may be introduced into the mixture simultaneously with the aqueous solution comprising the surfactant, and/or the aqueous solution comprising the co-solvent, and/or the additional hydrocarbon medium, each solution or medium being injected into the mixture from a different feed line 2a. This embodiment is preferable for example when the salinity of the aqueous solution is relatively high and prevents the solubilization of the surfactant.

Alternatively, instead of forming different aqueous solutions, an amount of surfactant and/or co-solvent may be simply added to the aqueous solution having a lower or a higher salinity than the initial salinity of the mixture, prior to its injection in the mixture. In this case, the aqueous solution having a lower or a higher salinity than the initial salinity of the mixture also comprising surfactant and/or so-solvent may be injected into the mixture from a first feed line 2a while the additional hydrocarbon medium may be introduced into the mixture through a different feed line 2a. This latter case is preferable when the surfactant and/or co-solvent are soluble in the aqueous solution having a lower or a higher salinity than the initial salinity of the mixture.

It goes without saying that in the absence of surfactants and/or co-solvents, the addition of such components may be avoided.

According to some embodiments, notably when the aqueous solution of higher or lower salinity further comprises an amount of surfactant and/or an amount of co-solvent, it may be introduced into the mixture with a flow rate of 0.01 to 10 mL/min, and preferably from 0.01 to 1 mL/min. For example, this flow rate may be from 0.01 to 0.05 mL/min; or from 0.05 to 1 mL/min; or from 1 to 2 mL/min; or from 2 to 3 mL/min; or from 3 to 4 mL/min; or from 4 to 5 mL/min; or from 5 to 6 mL/min; or from 6 to 7 mL/min; or from 7 to 8 mL/min; or from 8 to 9 mL/min; or from 9 to 10 mL/min. In this case, the hydrocarbon medium may be introduced into the mixture with the same flow rate as the flow rate of the above aqueous solution, or at a different flow rate, especially if the aqueous medium to hydrocarbon medium ratio is different from 1.

According to other embodiments, notably when the aqueous solution of higher or lower salinity is introduced separately and simultaneously with the aqueous solution comprising the surfactant and/or the aqueous solution comprising the co-solvent, each of these solutions may have a flow rate lower than the above flow rate. More particularly, this flow rate (preferably the same for all solutions introduced into the mixture) may be the above flow rate divided by the number of aqueous solutions introduced into the mixture. In this case, the hydrocarbon medium may be introduced into the mixture with a flow rate which corresponds to the sum of flow rates of the aqueous solutions, or at a different flow rate, especially if the aqueous medium to hydrocarbon medium ratio is different from 1.

According to other embodiments, during this step the surfactant concentration of the mixture increases. To do so, an aqueous solution having a surfactant concentration higher than the initial surfactant concentration of the mixture (for example a surfactant concentration of approximately 10%) may be continuously added into the mixture. In this case, the initial surfactant concentration of the mixture may be 0 or approximately 0. Therefore, the continuous addition of a solution of surfactant into the mixture results in the continuous increase of the surfactant concentration of the mixture.

According to other embodiments, during this step the surfactant concentration of the mixture decreases. To do so, an aqueous solution having a surfactant concentration lower than the initial surfactant concentration of the mixture (for example a surfactant concentration of 0%) may be continuously added into the mixture. Therefore, the continuous addition of this solution into the mixture results in the continuous decrease of the surfactant concentration of the mixture.

Again, in both cases, in order to keep the ratio of the aqueous medium to the hydrocarbon medium as well as preferably the concentration of the other components (inorganic salts, co-solvents) in the mixture constant during the step, additional hydrocarbon medium, an aqueous solution comprising an inorganic salt, and/or an aqueous solution comprising the co-solvent may be added into the mixture. In this case, the surfactant solution may be introduced into the mixture simultaneously with the aqueous solution comprising the inorganic salt, and/or the aqueous solution comprising the co-solvent, and/or the additional hydrocarbon medium, each solution or medium being injected into the mixture from a different feed line 2a. This embodiment is preferable for example when the solubilization of the surfactant becomes difficult due to the concentration of inorganic salt (salinity).

Alternatively, instead of forming different aqueous solutions, an amount of inorganic salt and/or co-solvent may be simply added to the surfactant solution, prior to its injection in the mixture. In this case, the surfactant solution also comprising an amount of inorganic and/or so-solvent may be injected into the mixture from a first feed line 2a while the additional hydrocarbon medium may be introduced into the mixture through a different feed line 2a. This latter case is preferable when the surfactant and/or co-solvent are soluble in the aqueous solution comprising the inorganic salt.

Again, it goes without saying that in the absence of inorganic salts and/or co-solvents in the mixture, the addition of such solutions may be avoided.

According to some embodiments, notably when the surfactant solution further comprises an amount of inorganic salt and/or an amount of co-solvent, it may be introduced into the mixture with a flow rate of 0.01 to 10 mL/min, and preferably from 0.01 to 1 mL/min. For example, this flow rate may be from 0.01 to 0.05 mL/min; or from 0.05 to 1 mL/min; or from 1 to 2 mL/min; or from 2 to 3 mL/min; or from 3 to 4 mL/min; or from 4 to 5 mL/min; or from 5 to 6 mL/min; or from 6 to 7 mL/min; or from 7 to 8 mL/min; or from 8 to 9 mL/min; or from 9 to 10 mL/min. In this case, the hydrocarbon medium may be introduced into the mixture with the same flow rate as the flow rate of the above aqueous solution, or at a different flow rate, especially if the aqueous medium to hydrocarbon medium ratio is different from 1.

According to other embodiments, notably when the surfactant solution is introduced separately and simultaneously with the aqueous solution comprising the inorganic and/or the aqueous solution comprising the co-solvent, each of these solutions may have a flow rate lower than the above flow rate. More particularly, this flow rate (preferably the same for all solutions introduced into the mixture) may be the above flow rate divided by the number of aqueous solutions introduced into the mixture. In this case, the hydrocarbon medium may be introduced into the mixture with a flow rate which corresponds to the sum of flow rates of the aqueous solutions, or at a different flow rate, especially if the aqueous medium to hydrocarbon medium ratio is different from 1.

According to yet other embodiments, during this step the co-solvent concentration of the mixture increases. To do so, an aqueous solution having a co-solvent concentration higher than the initial co-solvent concentration of the mixture (for example a co-solvent concentration of 10%) may be continuously added into the mixture. In this case, the initial co-solvent concentration of the mixture may be 0 or approximately 0. Therefore, the continuous addition of a solution of co-solvent into the mixture results in the continuous increase of the co-solvent concentration of the mixture.

According to other embodiments, during this step the co-solvent concentration of the mixture decreases. To do so, an aqueous solution having a co-solvent concentration lower than the initial co-solvent concentration of the mixture (for example a co-solvent concentration of 0%) may be continuously added into the mixture. In this case, the initial co-solvent concentration of the mixture may be for example 10%. Therefore, the continuous addition of this solution into the mixture results in the continuous decrease of the co-solvent concentration of the mixture.

Again, in both cases, in order to keep the ratio of the aqueous medium to the hydrocarbon medium as well as preferably the concentration of the other components (inorganic salts, surfactants) in the mixture constant during the step, additional hydrocarbon medium, an aqueous solution comprising an inorganic salt, and/or an aqueous solution comprising the surfactant may be added into the mixture. In this case, the co-solvent solution may be introduced into the mixture simultaneously with the aqueous solution comprising the inorganic salt, and/or the aqueous solution comprising the surfactant, and/or the additional hydrocarbon medium, each solution or medium being injected into the mixture from a different feed line 2a.

Alternatively, instead of forming different aqueous solutions, an amount of inorganic salt and/or surfactant may be simply added to the co-solvent solution, prior to its injection in the mixture. In this case, the co-solvent solution also comprising an amount of inorganic and/or surfactant may be injected into the mixture from a first feed line 2a while the additional amount of hydrocarbon medium may be introduced into the mixture through a different feed line 2a.

Again, it goes without saying that in the absence of inorganic salts and/or surfactants in the mixture, the addition of such solutions may be avoided.

According to some embodiments, notably when the co-solvent solution further comprises an amount of inorganic salt and/or an amount of surfactant it may be introduced into the mixture with a flow rate of 0.01 to 10 mL/min, and preferably from 0.01 to 1 mL/min. For example, this flow rate may be from 0.01 to 0.05 mL/min; or from 0.05 to 1 mL/min; or from 1 to 2 mL/min; or from 2 to 3 mL/min; or from 3 to 4 mL/min; or from 4 to 5 mL/min; or from 5 to 6 mL/min; or from 6 to 7 mL/min; or from 7 to 8 mL/min; or from 8 to 9 mL/min; or from 9 to 10 mL/min. In this case, the hydrocarbon medium may be introduced into the mixture with the same flow rate as the flow rate of the above aqueous solution, or at a different flow rate, especially if the aqueous medium to hydrocarbon medium ratio is different from 1.

According to other embodiments, notably when the co-solvent solution is introduced separately and simultaneously with the aqueous solution comprising the inorganic and/or the aqueous solution comprising the surfactant, each of these solutions may have a flow rate lower than the above flow rate. More particularly, this flow rate (preferably the same for all solutions introduced into the mixture) may be the above flow rate divided by the number of aqueous solutions introduced into the mixture. In this case, the hydrocarbon medium may be introduced into the mixture with a flow rate which corresponds to the sum of flow rates of the aqueous solutions, or at a different flow rate, especially if the aqueous medium to hydrocarbon medium ratio is different from 1.

In any of the above cases, during this step, and in order to maintain the volume of the mixture constant, the method may further comprise a step of withdrawing (or removing or discharging) part of the mixture from the chamber, this step being preferably carried out simultaneously with the introduction of the one or more aqueous solutions mentioned above and of the additional hydrocarbon medium into the mixture. The flow rate of the discharged mixture may correspond to the sum of flow rates of all aqueous solutions (salt solution and/or surfactant solution and/or co-solvent solution) and mediums (hydrocarbon medium) introduced into the mixture.

The method according to the invention further comprises a step of continuously measuring the conductivity of the mixture. Preferably, this step is carried out simultaneously with the step of continuously altering the concentration of at least one component in the mixture. In other words, while the concentration of at least one component in the mixture is altered (decreased or increased), the conductivity of the mixture is measured in a continuous manner, and preferably during the whole duration of the step of altering the concentration of at least one component in the mixture. This makes it possible to study the effect of the at least one component on the conductivity of the mixture.

More particularly, when the mixture is initially a water-in-oil emulsion, the conductivity of the mixture is essentially 0 (for example lower than 1 mS/cm; or lower than 0.5 mS/cm; or lower than 0.3 mS/cm; or lower than 0.2 mS/cm; or lower than 0.1 mS/cm), or even 0, while when the mixture is an oil-in-water emulsion, the conductivity of the mixture is higher than 0, for example equal to or higher than 10 mS/cm, or equal to or higher than 15 mS/cm, or equal to or higher than 20 mS/cm, or equal to or higher than 25 mS/cm, or equal to or higher than 30 mS/cm, or equal to or higher than 35 mS/cm, or equal to or higher than 40 mS/cm, or equal to or higher than 45 mS/cm, or equal to or higher than 50 mS/cm, or equal to or higher than 55 mS/cm.

Thus, at the moment of the phase inversion, the conductivity either rapidly decreases from a value which is higher than 0 to 0 (when the oil-in-water emulsion becomes a water-in-oil emulsion), or rapidly increases from a value which is proximate to 0 (or 0) to a value higher than 0, as explained above (when the water-in-oil emulsion becomes an oil-in-water emulsion). Furthermore, the moment of the phase inversion corresponds to an optimal formulation and at the formation of a Winsor III microemulsion system. Thus, at the moment when the optimal formulation is formed, the conductivity exhibits a sudden change. For (not optimal) formulations which are not capable of forming a Winsor III microemulsion system, this sudden change in conductivity is not observed.

When the component whose concentration is altered is the inorganic salt, by “sudden change in conductivity” is preferably meant an increase or decrease in conductivity at a rate of more than 5 mS/cm per g/L of salt, preferably more than 10 mS/cm per g/L of salt, even more preferably more than 15 mS/cm per g/L of salt.

When the component whose concentration is altered is the surfactant, by “sudden change in conductivity” is preferably meant an increase or decrease in conductivity at a rate of more than 5 mS/cm per g/L of surfactant, preferably more than 10 mS/cm per g/L of surfactant, even more preferably more than 15 mS/cm per g/L of surfactant.

When the component whose concentration is altered is the co-solvent, by “sudden change in conductivity” is preferably meant an increase or decrease in conductivity at a rate of more than 5 mS/cm per g/L of co-solvent, preferably more than 10 mS/cm per g/L of co-solvent, even more preferably more than 15 mS/cm per g/L of co-solvent.

In case the formulation is capable of forming a Winsor III microemulsion system, by altering the concentration of at least one component in the mixture, for example by altering the salinity, the surfactant concentration or the co-solvent concentration, one can lead the mixture to a phase transition.

For example, by increasing the salinity of the mixture, the conductivity may undergo a sudden drop from a value of at least 10 mS/cm to a value close to 0, which corresponds to the formation of the Winsor III microemulsion system. This makes it possible to identify the optimal salinity at which a specific formulation of surfactant may lead to a Winsor III microemulsion system and therefore to an increase in hydrocarbon recovery.

Similarly, by continuously decreasing the salinity of the mixture, the conductivity may increase from a value close to 0, to a higher value of at least 10 mS/cm for example. At the point of sudden increase in conductivity, the formation of the Winsor III microemulsion system may be observed.

Similarly again, by continuously increasing or decreasing the surfactant concentration of the mixture having a fixed salinity, at the moment of the phase inversion, a sudden drop or sudden increase in conductivity may be observed, which corresponds to the formation of the Winsor III microemulsion system. This makes it possible to identify an optimal surfactant formulation at a specific salinity in order to increase in hydrocarbon recovery.

Similarly, by continuously increasing the co-solvent concentration of the mixture having a fixed salinity (and preferably a fixed surfactant concentration), at the moment of the phase inversion, a sudden drop in conductivity may be observed, which corresponds to the formation of the Winsor III microemulsion system.

Inversely, by continuously decreasing the co-solvent concentration of the mixture having a fixed salinity (and preferably a fixed surfactant concentration), at the moment of the phase inversion, a sudden increase in conductivity may be observed, which corresponds to the formation of the Winsor III microemulsion system.

The method of the present invention therefore makes it possible to rapidly and continuously scan a variety of surfactant formulations, co-solvent formulations, and a variety of salinities in order to identify the optimal formulations and conditions that, when injected in a subterranean formation, can increase hydrocarbon recovery.

The method according to the present invention may be carried out at a constant temperature. This temperature may be from 25 to 140° C., preferably from 30 to 120° C., and more preferably from 40 to 100° C. For example, this temperature may be from 25 to 30° C.; or from 30 to 35° C.; or from 35 to 40° C.; or from 40 to 45° C.; or from 45 to 50° C.; or from 50 to 55° C.; or from 55 to 60° C.; or from 60 to 65° C.; or from 65 to 70° C.; or from 70 to 75° C.; or from 75 to 80° C.; or from 80 to 85° C.; or from 85 to 90° C.; or from 90 to 95° C.; or from 95 to 100° C.; or from 100 to 105° C.; or from 105 to 110° C.; or from 110 to 115° C.; or from 115 to 120° C.; or from 120 to 125° C.; or from 125 to 130° C.; or from 130 to 135° C.; or from 135 to 140° C. It is preferable that the temperature at which the method is implemented is proximate to the temperature of the subterranean formation.

The method according to the present invention may be carried out at a constant pressure. This pressure may be from 1 to 5 bars.

In some alternative embodiments, the component the concentration of which is altered may be an additive. The method may be implemented similarly to what was described above, for example with respect to the variation of the concentration of surfactant.

In some embodiments, after identifying the optimal salinity, and/or the optimal surfactant formulation, and/or the optimal co-solvent formulation, the method of the present invention may comprise a step of adding to the mixture (having the optimal salinity and/or the optimal surfactant formulation and/or the optimal co-solvent formulation) at least one additive. This makes it possible to study the influence of such additive (a polymer for example) on the identified optimal conditions.

Although the addition of surfactant, co-solvent and additive has been described above via an aqueous solution, such compounds may alternatively (or additionally) be introduced into the mixture together with the hydrocarbon medium.

According to some embodiments, the method of the invention is carried out without any pause.

According to other embodiments, one or more pauses may be provided while implementing the method of the invention. The continuous injection of fluid (and optionally the continuous measurement of the conductivity) may be paused for a certain period of time.

### EXAMPLES

The following examples illustrate the invention without limiting it.

### Example 1

For this example, 10 mixtures (systems) were prepared according to the table below. The mixtures comprised an aqueous medium having a salinity of 200 g/L and at least an anionic surfactant and a nonionic surfactant, and a hydrocarbon medium chosen from:
A: a crude oil of a viscosity of 82.5 mPa·s and a density at 25° C. of 0.91,
B: a crude oil of a viscosity of 15.3 mPa·s and a density at 25° C. of 0.86,
C: a crude oil of a viscosity of 175.7 mPa·s and a density at 25° C. of 0.92
D: a crude oil of a viscosity of 15.8 mPa·s and a density at 25° C. of 0.90.

The volumetric ratio of aqueous medium to hydrocarbon medium was 1 for all the mixtures.

| | Hydrocarbon | | | Temperature |
|---|---|---|---|---|
| System | medium | surfactant | additive | (° C.) |
| 1 | B | 1% S1 + | — | 55 |
| | | 0.5% S2 | | |
| 2 | B | 1% S1 + | — | 55 |
| | | 0.5% S3 | | |
| 3 | B | 1% S1 + | — | 55 |
| | | 1% S3 | | |
| 4 | A | 0.25% S4 + | 0.5% Na₂CO₃ | 55 |
| | | 0.0625% S2 | | |
| 5 | D | 0.25% S4 + | 0.5% Na₂CO₃ | 55 |
| | | 0.0625% S2 | | |
| 6 | A | 0.5% S4 + | 0.5% Na₂CO₃ | 55 |
| | | 0.125% S2 | | |
| 7 | A | 1% S1 + | 0.5% Na₂CO₃ | 40 |
| | | 0.5% S2 | | |
| 8 | A | 1% S1 + | 0.5% Na₂CO₃ | 55 |
| | | 0.5% S2 | | |
| 9 | A | 1% S1 + | 0.5% Na₂CO₃ | 65 |
| | | 0.5% S2 | | |
| 10 | C | 0.6% S4 + | — | 55 |
| | | 0.9% S3 | | |

S1 = C₁₆₋₁₈—O—(CH₂—CH(CH₃)—O)₄—SO₃Na
S2 = C₁₃—O—(CH₂CH₂O)₁₃—H
S3 = C₁₀—O—(CH₂CH₂O)₁₀—H
S4 = C₁₆₋₁₈—O—(CH₂—CH(CH₃)—O)₇—(CH₂—CH₂—O)_{0.1}—SO₃Na

The salinity of the systems 1 to 10 was modified according to two methods.

The first method (Method 1) was carried out by preparing a plurality of solutions of each one of the above systems with different salinities. These solutions were prepared in pipettes which were sealed at the bottom. The solutions were then stirred to enable contact of the phases and were then left to rest until visual changes were not recorded. The type of systems (Winsor I, Winsor III, Winsor II) was observed at equilibrium and the optimal salinity was recorded when a balanced Winsor III system was obtained.

The second method (Method 2) was the method according to the invention, according to which each system was placed in a device according to the invention and the salinity of each system was continuously decreased from 200 g/L by the addition of a solution having a salinity of 0 g/L and having the same concentration of surfactants as the initial solution. Oil was added to the system at the same flow rate. During this addition, the water to oil ratio was maintained constant and each system was continuously stirred.

At the same time, the conductivity of each system was continuously measured in order to identify the optimal salinity for each system, in other words the salinity at which the phase inversion occurred.

The results are illustrated in the table below.

| | Optimal salinity (g/L) | Optimal salinity (g/L) |
|---|---|---|
| System | Method 1 | Method 2 |
| 1 | 89 | 91 |
| 2 | 85 | 91 |
| 3 | 110 | 114 |
| 4 | 81 | 85 |
| 5 | 55 | 53 |
| 6 | 79 | 80 |
| 7 | 150 | 150 |
| 8 | 134 | 127 |
| 9 | 120 | 110 |
| 10 | 87 | 84 |

As illustrated in the table above, the two methods give very similar results for each one of the systems, which means that the method according to the invention may determine the formation of a Winsor III microemulsion system in an efficient and faster manner.

### Example 2

In this example, two mixtures were prepared.

Mixture A comprised an aqueous medium having a salinity of 110 g/L and crude oil B (as detailed in example 1) in a water to oil ratio of 1. This mixture further comprised 1% of surfactant S1 (as shown in example 1) of the total weight of the mixture and 0.5% of surfactant S2 (as shown in example 1) of the total weight of the mixture.

Mixture B comprised an aqueous medium having a salinity of 70 g/L and crude oil B (as detailed in example 1) in a water to oil ratio of 1. This mixture further comprised 1% of surfactant S1 (as shown in example 1) of the total weight of the mixture and 0.5% of surfactant C₁₇—O—(CH₂CH₂O)₁₂—H of the total weight of the mixture.

Each mixture was placed in a device according to the invention and the salinity of each mixture was continuously decreased by the addition of a solution having a salinity of 0 g/L and having the same concentration of surfactants as the initial solution. During this addition, the water to oil ratio was maintained constant and each mixture was continuously stirred.

At the same time, the conductivity of each mixture was continuously measured in order to determine (or not) the optimal salinity for each mixture at which the phase inversion occurs (or not).

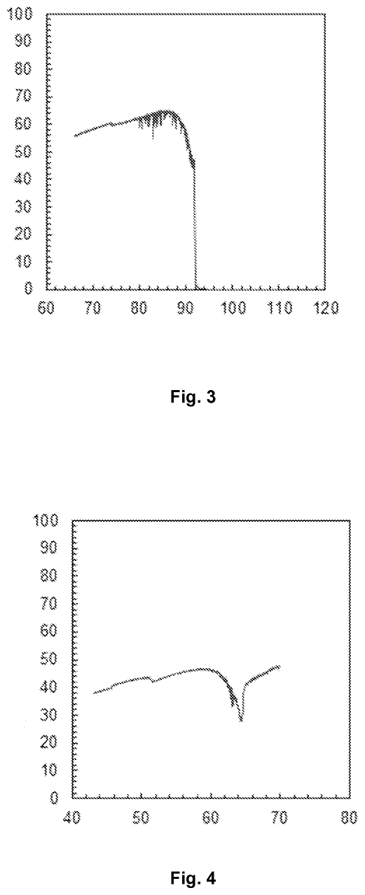

As shown in FIG. 3, the salinity of mixture A continuously increased from an initial value of 66 g/L. A sudden drop in conductivity was observed at around 92 g/L, which corresponds to the phase inversion and to the formation of the Winsor III microemulsion system at equilibrium. This value therefore corresponds to the optimal salinity at which the surfactant formulation of mixture A leads to a Winsor III microemulsion system.

On the contrary, as shown in FIG. 4, the salinity of mixture B continuously increased from an initial value of 43 g/L. Although a small drop in conductivity was observed around 65 g/L, the conductivity then increased and no phase inversion (or formation of a Winsor III microemulsion system) was observed.

Therefore, the method of the invention makes it possible to identify surfactant formulations that lead to the formation of a Winsor III microemulsion system as well as the optimal salinity at which this microemulsion is formed.

1. A dynamic method for determining the formation of a Winsor III microemulsion system, the method comprising the steps of:
providing a mixture of an aqueous medium and a hydrocarbon medium in a chamber;
continuously altering the concentration of at least one component in the mixture, while the ratio of the aqueous medium to the hydrocarbon medium remains constant and while stirring the mixture; and
continuously measuring at least one physicochemical property of the mixture.

2. The method according to claim 1, wherein the concentration of only one component in the mixture is altered, while the concentration of the other components of the mixture remains constant.

3. The method according to claim 1, wherein the aqueous medium is or derives from produced water, fresh water, aquifer water, formation water, sea water or combinations thereof and/or wherein the aqueous medium has an initial salinity from 0 to 300 g/L.

4. The method according to claim 1, wherein the hydrocarbon medium is a hydrocarbon fluid recovered from a subterranean formation.

5. The method according to claim 1, wherein the mixture is initially a water-in-oil emulsion or an oil-in-water emulsion.

6. (canceled)

7. The method according to claim 1, wherein the ratio of the aqueous medium to the hydrocarbon medium is from 0.2 to 5.

8. The method according to claim 1, wherein the mixture comprises a surfactant and wherein the surfactant has an initial concentration in the mixture from 0.001 to 30%.

9-10. (canceled)

11. The method according to claim 1, wherein the mixture comprises a co-solvent and wherein the co-solvent has an initial concentration in the mixture from 0.001 to 30%.

12. (canceled)

13. The method according to claim 1, wherein the at least one component is an inorganic salt, and/or a surfactant, and/or a co-solvent and wherein the surfactant is chosen from a surfactant of formula (VI):
R¹⁴—O—(CH₂—CH(CH₃)—O)ₖ—(CH₂CH₂O)ₚ—H (VI)
wherein:
R¹⁴ is a linear or branched alkyl group having from 1 to 24 carbon atoms;
p is a rational number from 1 to 30;
k is a rational number from 0 to 30;
and a surfactant of formula (VII):
R¹⁴—O—(CH₂—CH(CH₃)—O)ₓ—(CH₂—CH₂—O)_{y}—(CH₂)_{w}—X⁻M⁺ (VII)
wherein:
R¹⁴ is a linear or branched alkyl group having from 1 to 24 carbon atoms;
x is a number from 2 to 24; and
y is a number from 0 to 24;
w is a number from 0 to 2;
X⁻ is an anionic group selected from the group of —OSO₃—, —R¹⁵—SO₃—, —SO₃—, or —R¹⁵—COO—; and
M⁺ is a hydrogen atom or a cation;
as well as their mixtures.

14. (canceled)

15. The method according to claim 1, which comprises continuously adding an aqueous solution and additional hydrocarbon medium to the mixture in the chamber and/or continuously withdrawing part of the mixture from the chamber.

16. (canceled)

17. The method according to claim 1, wherein altering the concentration of the at least one component is performed by increasing said concentration in the mixture and/or decreasing its concentration in the mixture.

18. The method according to claim 15, wherein the aqueous solution and/or the additional hydrocarbon medium comprises the component the concentration of which is altered, in a higher concentration than in the mixture.

19-22. (canceled)

23. The method according to claim 15, wherein the aqueous solution and/or the additional hydrocarbon medium does not comprise the component the concentration of which is altered, or comprises the component the concentration of which is altered in a lower concentration than in the mixture.

24-26. (canceled)

27. The method according to claim 1, being carried out at a constant temperature and/or at constant pressure, wherein the temperature is from 25° C. to 140° C. and/or wherein the pressure is from 1 to 5 bars.

28-29. (canceled)

30. The method according to claim 1, wherein the physicochemical property of the mixture is chosen from conductivity, viscosity and light backscattering.

31. The method according to claim 30, wherein the physicochemical property is conductivity and wherein the method further comprises a step of determining the concentration of the component at which the conductivity suddenly decreases from a value higher than 0 to substantially 0 and/or at which the conductivity suddenly increases from a value of substantially 0 to a value higher than 0.

32. (canceled)

33. A device for determining the formation of a Winsor III microemulsion system, the device comprising:
a chamber (1) configured to receive a fluid sample;
at least two feed lines (2a) for continuously feeding two respective fluids to the chamber (1);
at least one discharge line (3a) for continuously withdrawing fluid from the chamber (1);
at least one sensor for measuring at least one physicochemical property of the fluid sample in the chamber (1); and
a stirring system (4) for stirring fluid in the chamber (1).

34. The device according to claim 33, wherein the physicochemical property of the mixture is chosen from conductivity, viscosity and light backscattering and/or wherein the sensor is a conductivity sensor (5).

35. (canceled)

36. The device according to claim 33, further comprising a sensor for measuring the temperature of the fluid sample in the chamber (1) and/or a system for regulating the temperature of the chamber (1) and/or a cap (8) for sealing the chamber (1).

37-42. (canceled)

43. The device according to claim 33, wherein the fluid sample is a mixture of a first fluid and a second fluid, and wherein the first fluid of the mixture is an aqueous medium and the second fluid of the mixture is a hydrocarbon medium, and wherein two different fluids are injected into the chamber (1), each fluid being injected through a different feed line (2a).

44-45. (canceled)
